(19) United States
(12) Patent Application Publication
(10) Pub. No.: US 2004/0131164 A1
(43) Pub. Date: Jul. 8, 2004

(54) Method and apparatus for automated telephone call screening

(76) Inventor: Mark Wendell Gould, Baltimore, MD (US)

Correspondence Address: MARK W. GOULD, 4393 PARKTON ST., BALTIMORE, MD, 21229, US

(21) Appl. No.: 10/741,750

(22) Filed: Dec. 20, 2003

Related U.S. Application Data
(60) Provisional application No. 60/434,951, filed on Dec. 20, 2002.

(51) Int. Cl. H04M 1/64; H04M 1/56; H04M 15/06

(52) U.S. Cl. 379/88.19; 379/142.01

(57) ABSTRACT

Method and apparatus to automatically screen incoming telephone calls, wherein the caller identification (“Caller ID”) transmitted by the telephone company is received, compared to a list of stored caller identification criteria, and a telecommunication device, such as a telephone, answering machine, fax machine or computer modem, is activated or deactivated in response to unwanted or low-priority calls. The Caller ID information transmitted by the telephone company, such as date, time, number and/or name of the calling party, is used as the decision criteria to accept or intercept the call.

### CROSS-REFERENCE TO RELATED APPLICATIONS

This application claims the benefit of Provisional Patent Application Serial No. 60/434,951 filed Dec. 20, 2003 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to telecommunication devices, specifically to telecommunication devices that use Calling Line Identification, commonly known as “Caller ID”, to screen incoming telephone calls.

### BACKGROUND OF THE INVENTION

2. Discussion of Prior Art

Telephone service subscribers frequently receive unwanted calls from telemarketers and other persons. Therefore, local telephone companies offer Caller ID service to identify the calling party when the telephone rings, either shortly after (Bellcore protocol) or shortly before (British Telecom protocol) the first ring. The telephone company transmits one of two types of caller identification messages, a Single Data Message Format (“SDMF”) message or a Multiple Data Message Format (“MDMF”) message. An SDMF message contains the

date and time, and

telephone number of the calling party. An MDMF message contains the

date and time,

telephone number, and

name of the calling party. The telephone number and/or name field for an anonymous call contains a “P” for “private” or “O” for “out of area”.

Many telecommunication devices are available to receive and display the Caller ID. U.S. Pat. No. 4,582,956 to Doughty (1986), U.S. Pat. No. 4,924,496 to Figa et al. (1990) and U.S. Pat. No. 5,526,406 to Luneau (1996) are just a few examples. The disadvantage of these inventions is that the subscriber is interrupted by every call. The subscriber must look at, or listen to, the Caller ID for each call, and make the decision to answer the call. If the subscriber decides not to answer the call, the telephone continues to ring until their answering machine or voice mail service answers the call, or the caller eventually hangs up. Telemarketers, a major source of unwanted calls, are often quite persistent, calling back several times a day until a live person answers the phone. A method and apparatus is therefore desirable to automatically screen incoming telephone calls.

Anonymous calls (“private”, “out of area” and toll-free numbers) are usually the ones that annoy most telephone subscribers. “Private” and “out of area” voice and fax calls are typically placed by telemarketers to hide the origin and nature of their call, and to make finding and prosecuting them for illegal calls under federal and state law more difficult. Some telemarketers send a toll-free Caller ID number (area code “800”, “888”, etc.) to hide their location. Some telemarketers send a number, but no name to hide their identity. However, many companies and government agencies with whom the telephone subscriber may want to speak simply neglect to program their Private Branch exchange (“PBX”) Caller ID. Therefore, the automated call screening method and apparatus should give the telephone subscriber the option of allowing anonymous callers to leave a message to ensure that the subscriber does not miss an important call.

U.S. Pat. No. 4,277,649 to Sheinbein (1981) envisions that local telephone companies can provide a variety of automated call screening services to subscribers based upon the identity of the caller. For example, Verizon and other local telephone companies now offer

Anonymous Call Rejection,

Call Block, and

Call Intercept services. Anonymous Call Rejection service allows subscribers to block “private” calls. The subscriber's phone will not ring and the caller will hear an announcement that the subscriber does not accept blocked calls. Callers are instructed that if they wish to reach the subscriber, they must hang up and dial again without blocking (*67) their number. Call Block service gives the subscriber the ability to block calls from up to six numbers from which the subscriber does not wish to receive calls. When someone calls from one of these numbers, the subscriber's telephone will not ring. Call Intercept stops calls that do not provide a valid telephone number. These calls can appear as “anonymous,” “private,” “out of area” or “unavailable” on the subscriber's Caller ID unit. Unidentified callers are asked to record their name before the phone rings. When the subscriber answers the telephone, the subscriber hears the recording and decides whether or not to take the call. If the caller refuses to give their name, the subscriber's telephone does not ring.

These services have several disadvantages. The call screening is apparent to the caller, and the messages tell the caller how to circumvent the call screening. A rejected caller cannot leave a message so the subscriber may miss an important call from an unexpected source. Call Block and Call Intercept accept anonymous names and toll-free numbers used by some telemarketers. Call Intercept rings the subscriber's telephone for all callers who identify themselves, but to whom the subscriber may not want to talk. Anonymous Call Rejection is free with Caller ID service, but Call Block service costs $4 per month and Call Intercept service costs $5 per month, a total of $108 per year (Verizon service fees in Maryland as of December 2002). A method and apparatus is therefore desirable to make the call screening completely invisible to the caller, give the subscriber the option to allow rejected callers to leave a message, and eliminate the recurring monthly charge to the subscriber.

Several devices provide functionality similar “Anonymous Call Rejection” and “Call Block” services but without the recurring monthly charge. The Pacific Bell 1000M Caller ID unit answers “private” calls on the first ring, announces that such calls are not accepted, and then hangs up. The Bel∘Tronic AD100 Caller ID unit allows the user to block calls from up to 100 telephone numbers instead of just 6. This device answers blocked calls on the first ring, announces that such calls are not accepted, and then hangs up. The telephone subscriber saves a substantial amount of money each year by using these devices instead of the local telephone company's call screening services.

These devices have several disadvantages. The call screening is apparent to the caller, so the caller may try to circumvent the device. For example, the caller may call back from a public telephone. Rejected callers cannot leave a message so the subscriber may miss an important call from an unexpected source. A method and apparatus is therefore desirable to make the call screening completely invisible to the caller, and allow the subscriber to decide whether or not rejected callers can leave a message.

U.S. Pat. No. 5,351,289 to Logsdon and DuRand (1994) and U.S. Pat. No. 5,377,260 to Long (1994) teach automated call screening. These inventions have the advantage of blocking the telephone company's power ring signal until the Caller ID is received and processed so the subscriber is not disturbed by rejected calls. However, this advantage is also a disadvantage; blocking the power ring signal also blocks the telecommunication device from receiving the Caller ID. For example, a Caller ID cordless telephone cannot receive and display the Caller ID for the incoming call, defeating the purpose of a Caller ID cordless phone. Another disadvantage is that the device must be spliced into the telephone line at the point of entry into the premises in order to block the ringing of all extension telephones on the premises, or additional devices purchased and programmed for each telephone. Most consumers prefer to buy and program just one device and simply plug it into an existing telephone jack. U.S. Pat. No. 5,029,196 to Morganstein (1991) and U.S. Pat. No. 5,644,629 to Chow (1997) teach automated call routing. These inventions route an incoming call to a telephone or an answering machine based upon the Caller ID. These inventions have the advantage of blocking the telephone company's power ring signal until the Caller ID is received and processed so the subscriber is not disturbed by rejected calls. However, Chou's invention also blocks the telephone and answering machine from receiving the Caller ID. For example, a Caller ID cordless telephone cannot receive and display the Caller ID for the incoming call, defeating the purpose of a Caller ID cordless phone; a Caller ID answering machine cannot display the Caller ID as each message is played back and automatically dial the return call for the user. Morganstein overcomes this disadvantage by having the PBX switch re-transmit the Caller ID after connecting the telephone or answering machine. However, most Caller ID modems are receive-only to minimize manufacturing cost of products for the price-sensitive retail consumer market. A method and apparatus is therefore desirable that can be built into mass-market Caller ID products, such as telephones and answering machines, with little or no recurring manufacturing cost.

### BACKGROUND OF THE INVENTION

### Objects and Advantages

A method and apparatus is desirable that:

(a) silently and automatically screens incoming telephone calls using the Caller ID;

(b) is preprogrammed to intercept anonymous (“private”, “out of area” and “toll-free”) calls, typically placed by telemarketers, that annoy most telephone subscribers;

(c) may be reprogrammed by the subscriber to accept or intercept calls from specific area codes, exchanges and telephone numbers for maximum telephone privacy;

(d) makes the screening process completely invisible to the caller so that rejected callers cannot tell that their call has been intercepted;

(e) stops the subscriber's telephone from ringing when an unwanted or low-priority call is received;

(f) gives the subscriber the option to allow rejected callers to leave a message;

(g) can be installed quickly and easily by the average person using standard modular telephone cords;

(h) allows the subscriber's Caller ID devices, such as a Caller ID telephone or answering machine, to receive the Caller ID so the devices retain all of their intended functionality and usefulness;

(i) can be built into mass-market telecommunication products, such as telephones, answering machines and fax machines, with little or no recurring manufacturing cost.

### SUMMARY

The present invention is a method and apparatus to silently and automatically screen incoming telephone calls using the caller identification information transmitted by the telephone company. Unwanted and low-priority calls are answered by the subscriber's telephone answering machine or voice mail service, or unanswered, at the discretion of the subscriber.

### DRAWINGS

In the drawings, closely relate figures have the same number but different alphabetic suffixes.

FIG. 1A is a simplied block diagram of a generic Caller ID telephone answering machine. FIG. 1B is the flow chart for the method that can be added to the machine as a software function to improve the utility of the machine with little or no recurring manufacturing cost.

FIG. 2A is a simplied block diagram of a generic Caller ID telephone. FIG. 2B is the flow chart for the method that can be added to the telephone as a software function to improve the utility of the telephone with little or no recurring manufacturing cost.

FIGS. 3A, 3B and 3C illustrate how a stand-alone embodiment of the method and apparatus, identified as “Call Sentry”, connects to an existing telephone(s) and answering machine.

FIG. 4A is a simplied block diagram of the stand-alone embodiment to retrofit almost any telephone or answering machine. FIG. 4B is the flow chart for the method implemented by the apparatus, essentially a combination of FIGS. 1B and 2B.

### DRAWINGS

### List of Reference Numerals

### DETAILED DESCRIPTION

### Preferred Embodiment

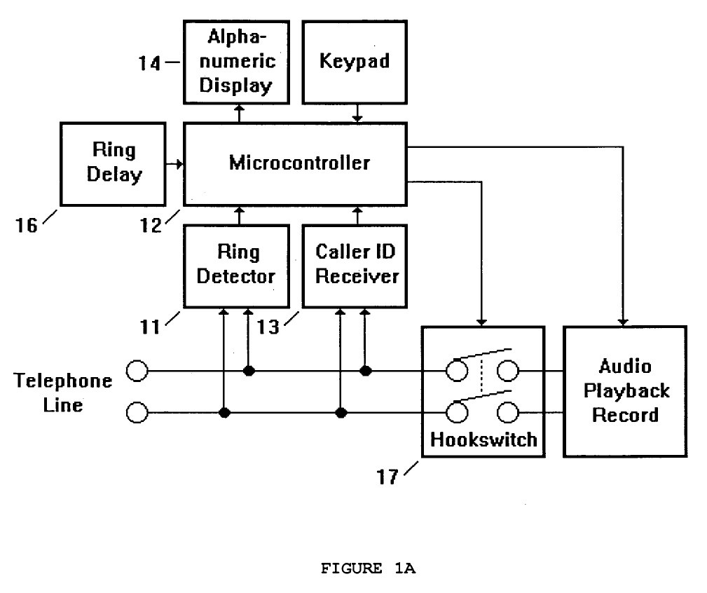

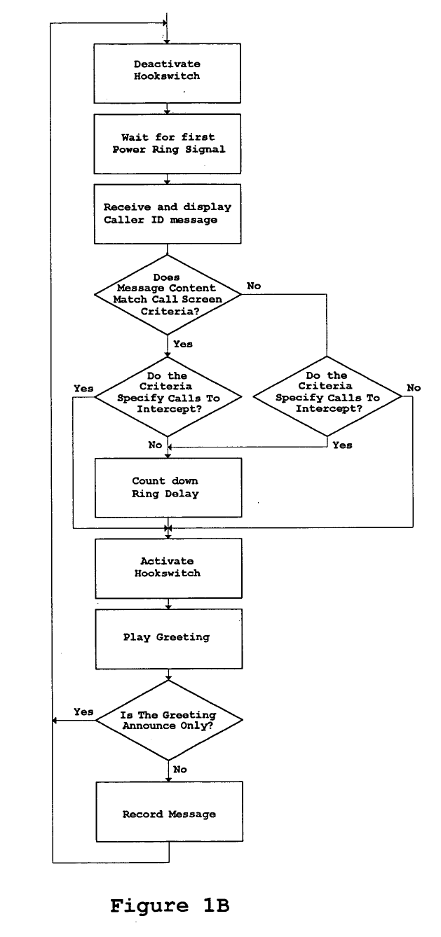

FIGS. 1A and 1B

The preferred embodiment for the method is a Caller ID answering machine. Answering machines are widely accepted and used by the general public. The machines are fast and easy to install; simply plug the machine into any telephone jack and power outlet. The owner sets the ring delay (typically 2 to 9 rings) to allow sufficient time to answer the telephone before the answering machine goes on-hook to take the call.

FIG. 1A is a simplified block diagram of a generic Caller ID answering machine. Ring Signal Detector 11 transmits a pulse to Microcontroller 12 each time it detects a power ring signal. Caller ID Receiver 13 detects and transmits the caller identification message to Microcontroller 12, either shortly after (Bellcore protocol) or shortly before (British Telecom protocol) the first ring. Microcontroller 12 decodes and displays the message on Display 14. Microcontroller 12 counts the number of rings indicated by Ring Delay 16 and then activates Hookswitch 17 to answer the call.

The physical and electrical design of Caller ID Receiver 13 and its associated Direct Access Arrangement (“DAA”) varies by country. For example, telephone companies in the United States and other countries use a 1200 baud FSK modem to transmit the Caller ID message while telephone companies in the Netherlands and other countries use a DTMF tone generator. Some manufacturers combine the Caller ID Receiver and Ring Signal Detector into a single integrated circuit (“IC”). Regardless of the Caller ID standard and means of transmission used in any particular country, the purpose of Caller ID Receiver 13 remains the same. The Bellcore standard used in the United States is cited herein for convenience only; the present invention is applicable to other Caller ID standards worldwide.

### OPERATION OF THE INVENTION

Caller ID answering machines already contain all of the components required to implement the present invention. Only a software revision is necessary to implement the present invention.

FIG. 1B illustrates the call screening method (logic) executed by Microcontroller 12 in FIG. 1A. After decoding and displaying the caller identification message, Microcontroller 12 compares the contents of the caller identification message to the stored caller identification criteria that specifies whether to accept or intercept the call. To accept the call, Microcontroller 12 activates Hookswitch 17 after the usual number of rings to allow the owner time to answer the call. To intercept the call, Microcontroller 12 activates Hookswitch 17 immediately to stop the telephone(s) from ringing and allow the rejected caller the opportunity to leave a message. However, the owner has the option of configuring the machine to “announce only” and hang up so rejected callers cannot leave a message.

The caller identification message content that can be used to screen each call are the

date and time,

telephone number, and

name of the calling party. The telephone number and/or name field for an anonymous call contains a “P” for “private” or “O” for “out of area”. For the convenience of the user, the apparatus is pre-programmed to intercept anonymous calls (“private”, “out of area” and “toll-free” numbers), typically from telemarketers, that annoy most people.

The list of caller identification criteria that Microcontroller 12 uses to screen each call can be stored in Electrically Erasable Programmable Read-Only Memory (“EEPROM”). This option allows users who want total control over their telephone privacy to custom-program the criteria. For example, the user may want to only accept calls from family and friends, or the user may want to only intercept calls from a few former friends and lovers. The user can therefore specify a list of complete telephone numbers, such as “4105551212”, to accept or intercept. The user can specify partial telephone numbers, such as area codes and exchanges, to accept or intercept calls based upon geographic region. For example, the number “505” specifies all calls from anywhere in New Mexico; “410357” specifies all calls from Parkton, Md. Partial telephone numbers can also specify organizations. For example, “410396” specifies numerous Baltimore City government departments at a variety of geographic locations. Calls can be accepted or intercepted based upon time. For example, the user may want to intercept all calls between the hours of 5:00 pm and 9:00 pm to reduce disruption of family activities such as dinner. Calls can be accepted or intercepted based upon name. For example, the user may want to accept all calls from “ACME INC” who has telephone lines and locations too numerous to list individually.

### DESCRIPTION AND OPERATION OF ALTERNATIVE EMBODIMENTS

One of several alternative embodiments for the method is a Caller ID telephone. Many people do not want an answering machine, or prefer voice mail service provided by their local telephone company. The advantage of this embodiment over the preferred embodiment is that the telephone will not ring at all if the call is intercepted; a telephone, fax machine or other telecommunication device used in conjunction with the preferred embodiment will ring once (Bellcore protocol) before the call is intercepted, a feature that some users may regard as a useful alert to check the answering machine or voice mail service for a possible message, a disruptive annoyance by other users. The disadvantage of this embodiment is that most people have several extension telephones they may want to keep in service.

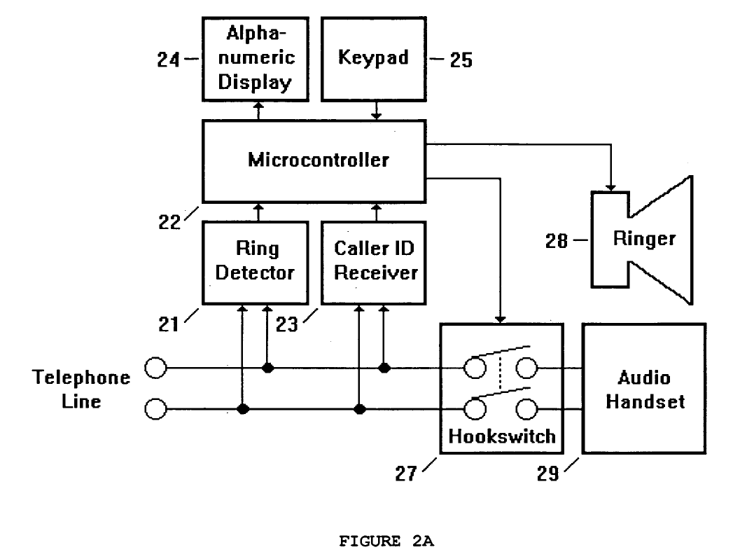

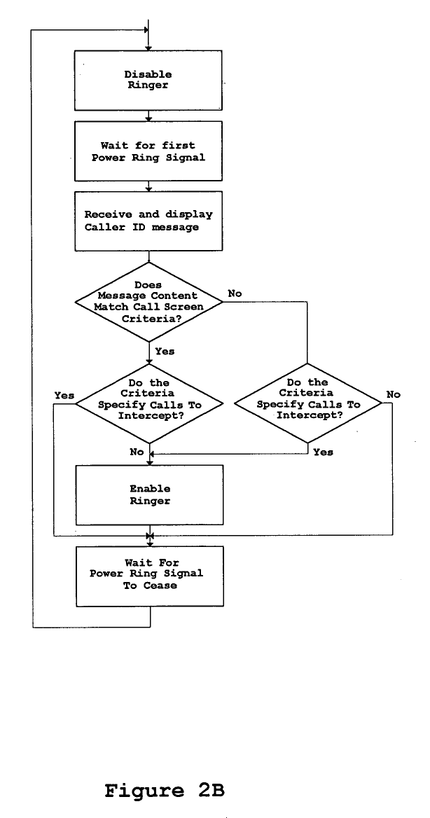

FIG. 2A is a simplified block diagram of a generic Caller ID telephone. Ring Signal Detector 21 transmits a pulse to Microcontroller 22 each time it detects a power ring signal; Microcontroller 22 in turn activates Ringer 28. Caller ID Receiver 23 detects and transmits the caller identification message to Microcontroller 22, either shortly after (Bellcore protocol) or shortly before (British Telecom protocol) the first ring. Microcontroller 22 decodes and displays the message on Display 24. When the owner presses the TALK switch on Keypad 25 or lifts Handset 29, Microcontroller 22 activates Hookswitch 27 to answer the call. The telephone contains all of the components required to implement the present invention. Only a software revision is necessary to implement the present invention.

FIG. 2B illustrates the call screening method (logic) executed by Microcontroller 22 in FIG. 2A. After decoding and displaying the caller identification message, Microcontroller 22 compares the contents of the caller identification message to the stored caller identification criteria that specifies whether to accept or intercept the call. To accept the call, Microcontroller 22 activates Ringer 28 as usual in response to the power ring signal. To intercept the call, Microcontroller 22 simply keeps Ringer 28 in the off state until the power ring signal ceases, either because the caller hung up or because an answering machine or voice mail service took the call. Microcontroller 22 can also keep Hookswitch 27 in the off state to prevent the user from accidentally answering the call.

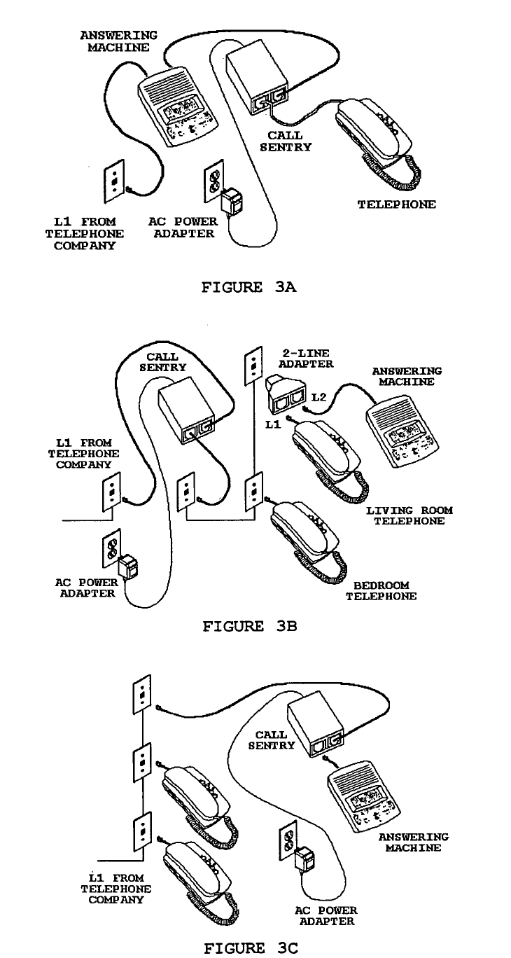

Another alternative embodiment for the method is a stand-alone “Call Sentry” device that can be connected to any telephone and answering machine quickly and easily using standard modular cords as shown in FIG. 3A. The advantage of this embodiment over the preferred embodiment is that the user need not replace their existing telephone and answering machine. A disadvantage of this embodiment is that most people have extension telephones. The user could turn off the ringer on all telephones except the one to which the apparatus is connected, but many people would not be able to hear the phone ring from all rooms in the premises. To leave all ringers on, the user could install this apparatus at the telephone line point of entry into the premises as shown in FIG. 3B, but many people would have to hire a technician to cut the telephone line and install the jacks. To overcome these disadvantages, the user could simply connect an answering machine instead of a telephone to the apparatus as shown in FIG. 3C, but most answering machines require a minimum of two rings to intercept a call instead of the preferred one ring.

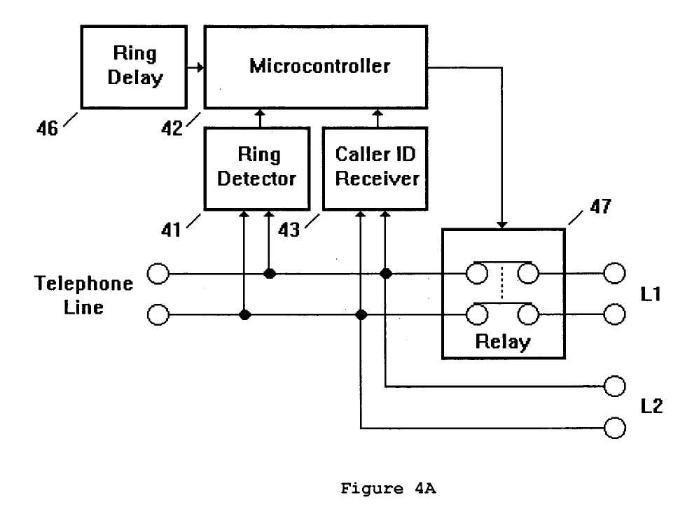

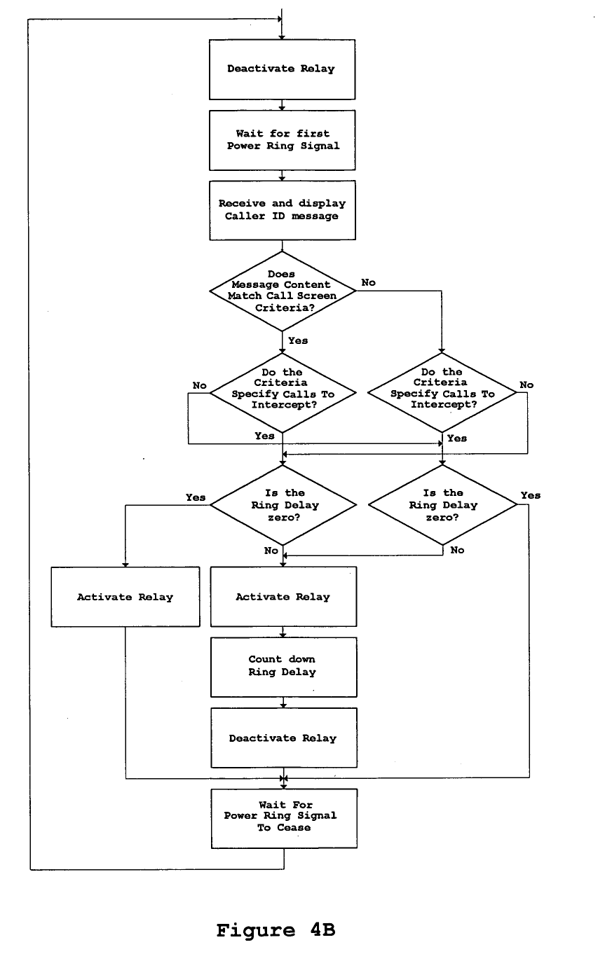

FIG. 4A is a simplified block diagram of this apparatus. Relay 47 is normally closed so a Caller ID telecomunication device can detect and receive the caller identification message transmitted by the telephone network, either shortly after (Bellcore protocol) or shortly before (British Telecom protocol) the first ring. Ring Signal Detector 41 transmits a pulse to Microcontroller 42 each time it detects a power ring signal. Caller ID Receiver 43 detects and transmits the caller identification message to Microcontroller 42. Microcontroller 42 decodes the message and executes the call screening method (logic) depicted in FIG. 5B to decide whether to accept or intercept the call. The value of Ring Delay 46 set by the user determines what action Microcontroller 42 takes to accept or intercept the call.

If Ring Delay 46 is zero, the telecommunication device connected to Relay 47 is typically a telephone or fax machine. Therefore, Microcontroller 42 does nothing to accept the call; the device rings normally. To intercept the call, Microcontroller 42 activates (opens) Relay 47 immediately to disconnect the power ring signal to the device until the power ring signal ceases, either because the caller hung up or because an answering machine or voice mail service took the call.

If Ring Delay 46 is non-zero, the telecommunication device connected to Relay 47 is typically an answering machine whose own ring delay is set to “2”. Therefore, Microcontroller 42 does nothing to intercept the call; the device rings normally and intercepts the call after 2 rings. To accept the call, Microcontroller 42 activates (opens) Relay 47 immediately to disconnect the power ring signal to the device. Microcontroller 42 counts the number of rings specified by Ring Delay 46 to allow the user time to answer the telephone, and then deactivates (closes) Relay 47 to let the device answer the call after 2 additional rings.

A unique feature of this apparatus is the switched and unswitched telephone lines in Modular Connnector 48 to simplify installation. In the United States, RJ11 residential wall jacks are usually wired for two telephone lines, L1 (red and green wires) and L2 (black and yellow wires), but most people only use L1. Therefore, this apparatus switches L1to control the ringing of all telephones located throughout the premises. However, this apparatus also connects L1 to the unused L2 for an answering machine. This feature enables the subscriber to connect the answering machine to L2 (unswitched L1) at a convenient location anywhere in the premises by using a standard 2-Line Adapter, as shown in FIG. 3B.

Another advantage of the L1-L2 feature is that the user can connect a standard 2-line answering machine (or two 1-line machines) to play a different message for rejected callers versus accepted callers. For example, the user could program the apparatus to accept, rather than intercept, anonymous calls and set Ring Delay 46 to zero. The user then programs the L1 machine to “announce only” a message such as “We do not accept anonymous calls.” after the second ring and then hang up. The user programs the L2 machine to greet accepted callers after the usual number of rings so the caller can leave a message if the user is unable to answer the telephone.

### Conclusions, Ramifications, and Scope of Invention

Thus the reader will see that the method and apparatus of the invention silently and automatically screens incoming telephone calls using the Caller ID. The method can be built into mass-market telecommunication products, such as telephones and answering machines, with little or no recurring manufacturing cost. These products are installed quickly and easily by the average person using standard modular telephone and power cords.

For the convenience of the purchaser, the products are preprogrammed to intercept anonymous (“private”, “out of area” and “toll-free”) calls, typically placed by telemarketers, that annoy most telephone subscribers. For maximum telephone privacy, the products could allow the purchaser to accept or intercept calls from specific area codes, exchanges and telephone numbers. The purchaser's telephone(s) only rings once in Bellcore countries, or not at all in British Telecom countries, when an unwanted or low-priority call is received.

The screening process completely invisible to the caller so that rejected callers cannot tell that their call has been intercepted. The purchaser can allow rejected callers to leave a message so that the purchaser does not miss an important call from an unexpected source.

The method and apparatus is compatible with all other telephone products that the purchaser may buy or already own. Caller ID products, such as a Caller ID telephone or answering machine, continue to receive the Caller ID for each call so that the products retain all of their intended functionality and usefulness.

While my above description contains many specificities, these should not be construed as limitations on the scope of the invention, but rather as an exemplication of one preferred embodiment thereof. Many other variations are possible. For example, the method and apparatus can be built into fax machines to block illegal junk faxes that waste valuable paper and ink, and cause unnecessary mechanical wear and tear to the machine. The method and apparatus can built into modem hardware and software to improve computer security by restricting incoming calls to certain calling locations. Even a simple stand-alone Caller ID display product, such as the AASTRA VisionPlus Mini 5050, can be converted to a powerful call screening device with only a minor software change, greatly improving its utility with no increase in manufacturing cost. The method and apparatus is adaptable to Bellcore, British Telecom and other telephone standards and products worldwide.

Accordingly, the scope of the invention should be determined not by the embodiment(s) illustrated, but by the appended claims and their legal equivalents.

I claim:

1. A method and apparatus for automatically screening incoming telephone calls using the caller identification information transmitted by the telephone company comprising:
(a) means for storing a list of caller identification criteria to accept or intercept incoming calls to the telecommunication device,
(b) means for detecting and receiving the caller identification information for each incoming call,
(c) means for comparing said incoming caller identification information to said stored criteria, and
(d) responsive to said comparing, means to activate or deactivate the telecommunication device.

2. A telecommunication device, such as a telephone answering machine, that incorporates the method and apparatus of claim 1 to activate the device immediately, instead of after the usual number of rings, to intercept the call.

3. A telecommunication device, such as telephone or fax machine, that incorporates the method and apparatus of claim 1 to deactivate the device for the duration of the power ring signal from the telephone network to intercept the call.

4. An apparatus that incorporates the method and apparatus of claim 1 to activate or deactivate a telecommunication device, such as a telephone, fax machine, answering machine, or computer modem, from the telephone network to intercept the call.
